(19) United States
(12) Patent Application Publication
(10) Pub. No.: US 2013/0036263 A1
(43) Pub. Date: Feb. 7, 2013

(54) SOLID STATE STORAGE DEVICE USING VOLATILE MEMORY

(71) Applicant: Shu-Min LIU, New Taipei City (TW)

(72) Inventor: Shu-Min LIU, New Taipei City (TW)

(21) Appl. No.: 13/195,149

(22) Filed: Aug. 1, 2011

(51) Int. Cl. G06F 12/06

(52) U.S. Cl. 711/105; 711/E12.078

(57) ABSTRACT

A solid state storage device using volatile memory comprises a first transmission interface, a memory controller, a memory module and a backup memory module. The memory module is comprised of a plurality of volatile memories. The backup memory module is comprised of a plurality of non-volatile memories. A plurality of volatile memories and a plurality of non-volatile memories are electrically coupled with the memory controller via memory connecting sockets. Before power failure, the memory controller controls the memory module to save internal data backup to the backup memory module. In addition, the memory controller controls memory module to save internal backup data back to the backup memory module when required.

### BACKGROUND OF THE INVENTION

1. Field of the Invention

The present invention relates to a storage device, in particular, the present invention relates to a storage device using volatile memory.

2. Description of Prior Art

In recent years, the development of electronic industries is prosperous and various electronic devices are popular and widely utilized in everyday life.

In terms of research and development of desktop computer, notebook computer, mobile phones and personal digital devices, the most important issues include data storage means, data storage capacity, data storage rates and data storage limitations. For example, a desktop computer frequently connects with a traditional disk reading hard disk by an IDE transmission cable via a Integrated Device Electronics (IDE) interface of a computer motherboard for accessing to the data saved in the hard disk. Nonetheless, the data transmission rate of an IDE interface is too slow, high speed interfaces such as a Universal Serial Bus (USB) interface or a Serial Advance Technology Attachment (SATA) are gradually applied in recent years.

With regards to a hard disk, a traditional hard disk utilizes corresponding mechanical movements between disk and disk head to perform data access. As a result, the data access rates are slow and difficult to improve. Therefore, an electronic Solid State Disk (SSD) is used for replacing a traditional disk reading hard disk for improving the data access rate.

Though, the data transmission rates of an USB and SATA interfaces are faster than data transmission rate of IDE interfaces. It is desired by users to provide interfaces with higher data transmission rates. In addition, data transmission rates of solid state disks are higher than those of traditional hard disks, and the data transmission rates are not higher than those of other types of memories (such as Dynamic Random Access Memory (DRAM)). Further, a solid state disk is comprised of a plurality of flash memories. A flash memory has a limited data erase count. Accordingly, it is risky, disadvantageous and unreliable to a user to completely replace traditional hard disks with flash memories when processing updates or transferring data of high speed (such as starting up data).

### SUMMARY OF THE INVENTION

The objective of the present invention is to provide a solid state storage device using volatile memory, where the volatile memory is used as a storage medium of the storage device for providing faster data access rates.

Another objective of the present invention is to provide a solid state storage device using volatile memory, where the device is connected to a non-volatile memory via a memory connecting socket so as to save the internal data backup in the volatile memory to the non-volatile memory, and save the internal backup data of the non-volatile memory back to the volatile memory. The volatile memory is used as a hard disk or a cache memory of large capacity.

The other objective of the present invention is to provide a solid state storage device using volatile memory, where the device is connected to a backup storage device via a second transmission interface and the internal data of the volatile memory internal data can be optionally save to a non-volatile memory or a backup storage device as data backup.

In order to achieve the above objectives, the present invention comprises: a first transmission interface, a memory controller, a memory module and a backup memory module. The memory module is comprised of a plurality of volatile memories and the backup memory module is comprised of a plurality of non-volatile memories. The plurality of volatile memories and the plurality of non-volatile memories are electrically coupled with memory controllers via memory connecting sockets. Before the power failure, the memory controller controls the memory module to save internal data backup to the backup memory module. In addition, the memory controller controls memory module to save internal backup data back to the backup memory module when required.

The advantages of the present invention include that the device is connected with a computer motherboard via a PCI-E interface or an e-SATA interface to achieve faster data transmission speed. In addition, data storage with volatile memories provides faster data access rates in contrast with data access rates provided by disk head reading of a traditional hard disk. Also, data storage with volatile memories does not have limited erase count in contrast with data storage with flash memories. Accordingly, data storage with volatile memories provides advantages such as faster data access rates and lower usage cost. Further, a volatile memory is powered by a battery or a power cord. Before power failure, the data backup is saved to a backup memory module or a backup storage device which improve the disadvantage that the data of a volatile memory is lost after power failure. Consequently, a volatile memory is used as a cache memory and also used as a solid state disk.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1A is a front view of the first embodiment according to the present invention;

FIG. 1B is a back view of the first embodiment according to the present invention;

FIG. 2 is a connecting schematic diagram of the first embodiment according to the present invention;

FIG. 3 is a solid diagram of the second embodiment according to the present invention;

FIG. 4 is a solid diagram of the third embodiment according to the present invention;

FIG. 5 is a block diagram of a preferred embodiment according to the present invention; and

FIG. 6 is a connecting schematic diagram of a fourth embodiment according to the present invention.

### DETAILED DESCRIPTION OF THE INVENTION

In cooperation with attached drawings, the technical contents and detailed description of the present invention are described thereinafter according to preferred embodiments, being not used to limit its executing scope. Any equivalent variation and modification made according to appended claims is all covered by the claims claimed by the present invention.

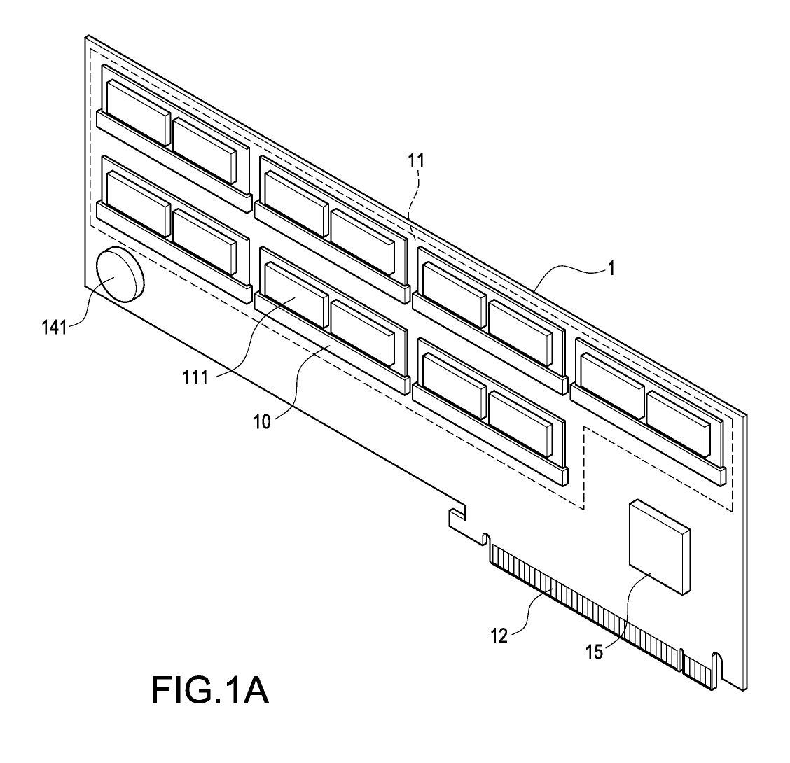

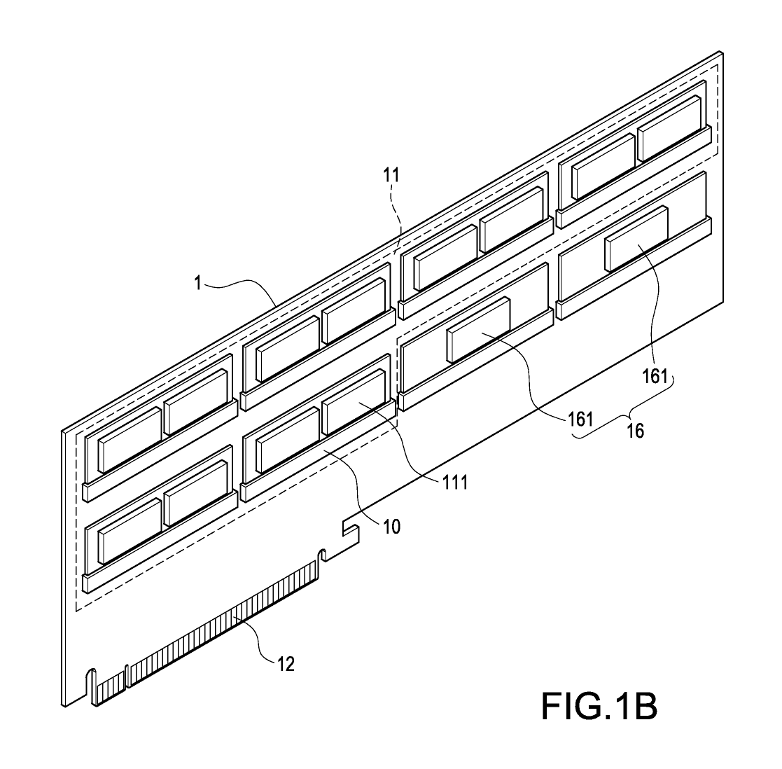

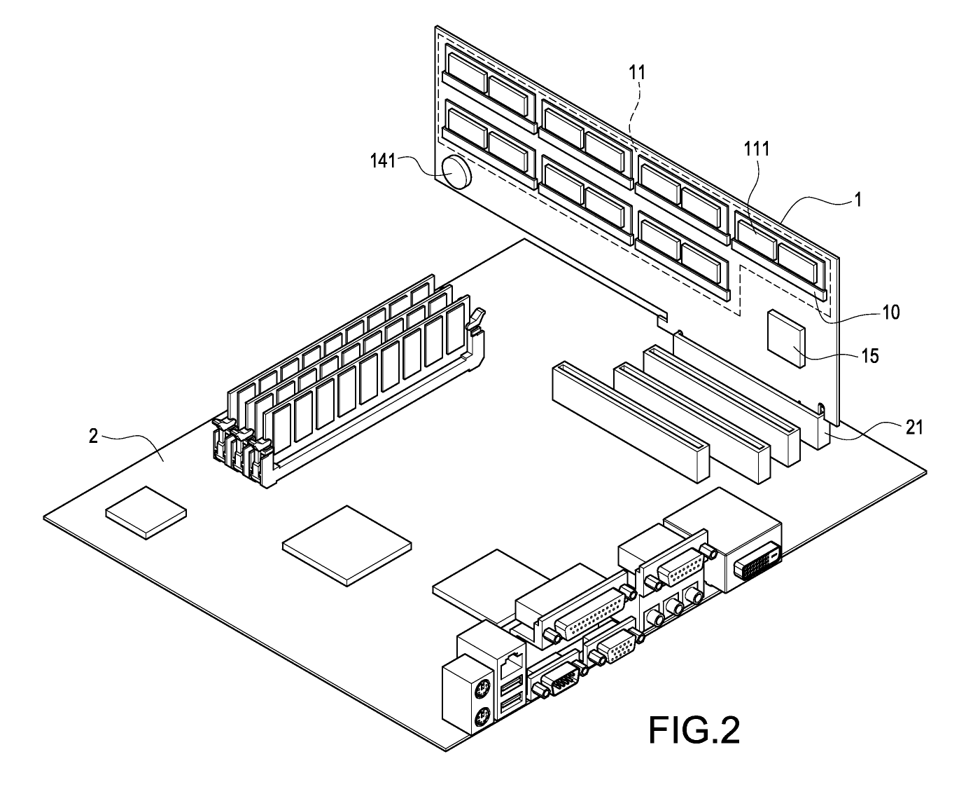

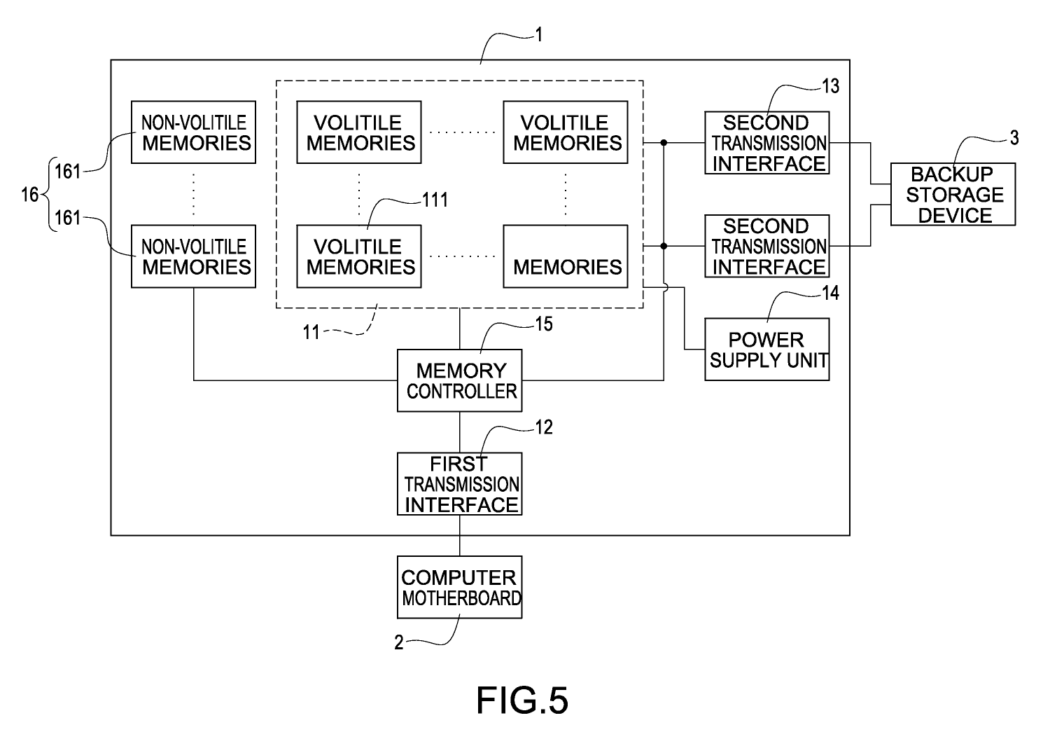

FIG. 1A, FIG. 1B and FIG. 2 are a front view, a back view and a connecting schematic diagram of the first embodiment according to the present invention. As shown in the diagram, solid state storage device using volatile memory 1 of the present invention (referred as the solid state storage device 1) comprises a plurality of memory connecting socket 10, a memory module 11, a first transmission interface 12, a power supply unit 14 (as shown in FIG. 5), a memory controller 15, and a backup memory module 16.

In the embodiment, the first transmission interface 12 is a Peripheral Component Interconnect Express (PCI-E) transmission interface. The solid state storage device 1 is electrically coupled with a PCI-E slot 21a of computer motherboard 2 via the first transmission interface 12. The solid state storage device 1 receives data transmitted from the computer motherboard 2 via the first transmission interface 12, and saves the transmitted data in the memory module 11.

The memory module 11 is comprised of a plurality of volatile memories 111. The plurality of volatile memories 111 is electrically coupled with the memory controller 15 via the plurality of memory connecting sockets 10. The backup memory module 16 is comprised of a plurality of non-volatile memories 161. The plurality of non-volatile memories 161 are electrically coupled with the memory controller 15 via the plurality of memory connecting sockets 10. Each volatile memory 111 can be comprised of one or more memory chips and each non-volatile memory 161 can be comprised of one or more memory chips and are not limited thereto.

The solid state storage device 1 saves data in the memory module 11. Before power failure, the memory module 11 is controlled to save internal data backup to the backup memory module 16 via the memory controller 15. When required (such as upon computer re-start), the backup memory module 16 is controlled to save internal backup data back to the memory module 11 via the memory controller 15. Thus, the solid state storage device 1 is allowed to achieve extremely high data access rates via the memory module 11, and to backup the data to the backup memory module 16 so as to keep the data from lost upon power failure.

In the embodiment, the plurality of volatile memories 111 can be a Double Data Rate Synchronous Dynamic Random Access Memories (DDR SDRAMs). In particular, the plurality of volatile memories 111 can be DDR3 SDRAMs, and the plurality of non-volatile memories 161 can be flash memories, but are not limited thereto.

As shown in FIG. 1A and FIG. 1B, a plurality of volatile memories 111 are installed on one side of the circuit board (for example a circuit board with PCI-E interface in the embodiment) in the solid state storage device 1. A plurality of volatile memories 111 and a plurality of non-volatile memories 161 are installed on the other side of the circuit board. In addition, the power supply unit 14 and the memory controller 15 are optionally installed on either side of the circuit board, and are not limited thereto.

The plurality of volatile memories 111 have extremely high data access rates. However, the saved data in the plurality of volatile memories 111 is lost after power failure. In addition to saving the data backup to the backup memory module 16, the power supply unit 14 provides required working power to the plurality of volatile memories 111. As shown in the diagram, the power supply unit 14 can be a battery 141 for providing required power to the plurality of volatile memories 111 in order to keep internal data from data lost after a computer is powered according to the embodiment.

It should be noted that, the plurality of memory connecting sockets 10 are Small Outline Dual In-line Memory Module (SO-DIMM) sockets, the plurality of volatile memories 111 and the plurality of non-volatile memories 161 are respectively inserted in the plurality of memory connecting sockets 10 and are electrically coupled with the memory controller 15 via the plurality of memory connecting sockets 10 for performing data transmission. The plurality of non-volatile memories 161 are electrically coupled with the memory controller 15 via two or more than two memory connecting sockets 10. The solid state storage device 1 saves internal data backup in the memory module 11 to the backup memory module 16 with Redundant Array of Independent Disks (RAID) via the plurality of memory connecting sockets 10. The above mentioned example is a preferred embodiment of the present invention and the scope of the invention is not limited thereto.

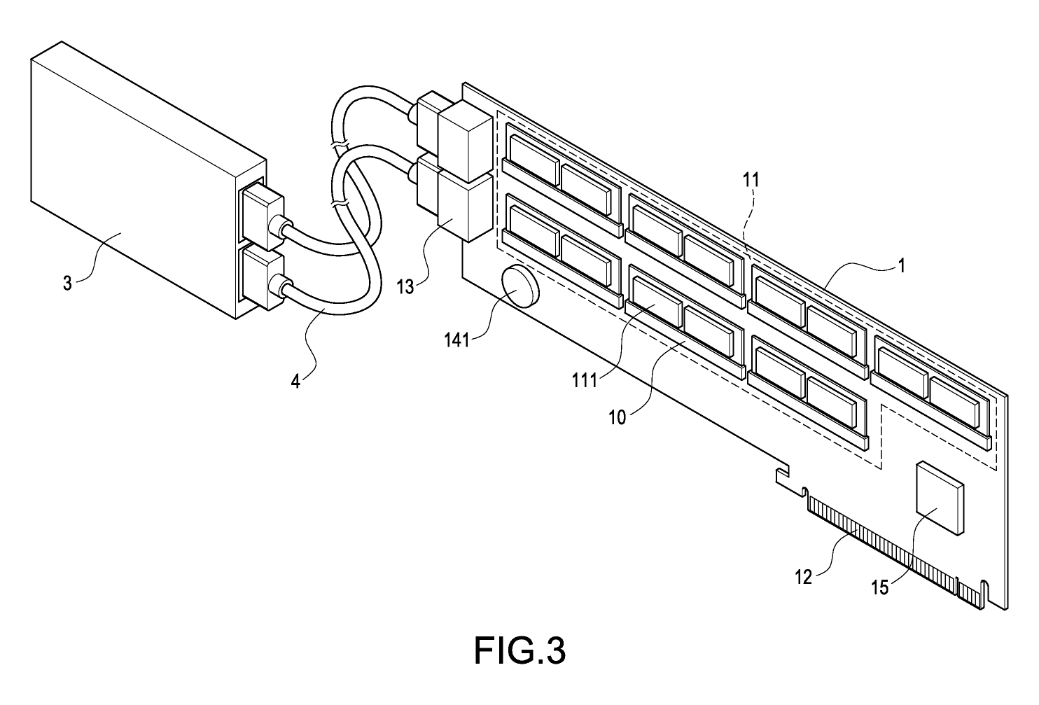

FIG. 3 is a solid diagram of the second embodiment according to the present invention. The solid state storage device lof the present invention further comprises a second transmission interface 13 and a backup storage device 3. The second transmission interface 13 is a Serial Advance Technology Attachment (SATA) transmission interface, the solid state storage device 1 connects with a SATA transmission cable 4 via the second transmission interface 13. The solid state storage device 1 is electrically coupled with the backup storage device 3 having SATA interface via the SATA transmission cable 4. It should be noted that, the backup storage device 3 may comprise a hard disk (such as a disk head reading hard disk or a solid state disk and is not limited thereto). The solid state storage device 1 connects with the backup storage device 3 via the second transmission interface 13 for saving the internal data backup of the memory module 11 to the backup storage device 3 and further for duplicating the internal data of the backup memory module 16 to the backup storage device 3.

In addition, the backup storage device 3 is comprised of multiple hard disks, and the quantity of the second transmission interface 13 can be two or more than two (the quantity is two in the example shown in the diagram). The solid state storage device 1 saves the internal data backup of the memory module 11 to the multiple hard disks in the backup storage device 3 with RAID via a plurality of second transmission interfaces 13. In addition, the solid state storage device 1 duplicates the internal data of the backup memory module 16 to the backup storage device 3 with RAID, whereby the data transferring rates of data backup is improved effectively. The quantity of hard disks in the backup storage device 3 and quantity of the second transmission interface 13 is determined by requirement and are not limited thereto.

As a result, when the memory module 11 and/or the backup memory module 16 are damaged, or when the storage space is insufficient, the backup storage device 3 can be utilized for performing data backup, also the data transferring rates of data backup can be increased by using RAID. Lastly, when required, the solid state storage device 1 controls the backup storage device 3 to save the internal backup data back to the memory module 11 or the backup memory module 16 via the memory controller 15.

It should be noted that the backup storage device 3 can be configured as an independent hard disk connecting with the computer motherboard 2 simply via the first transmission interface 12 and the second transmission interface 13 for receiving and transferring data. It should be considered as another embodiment of the present invention and is not limited thereto.

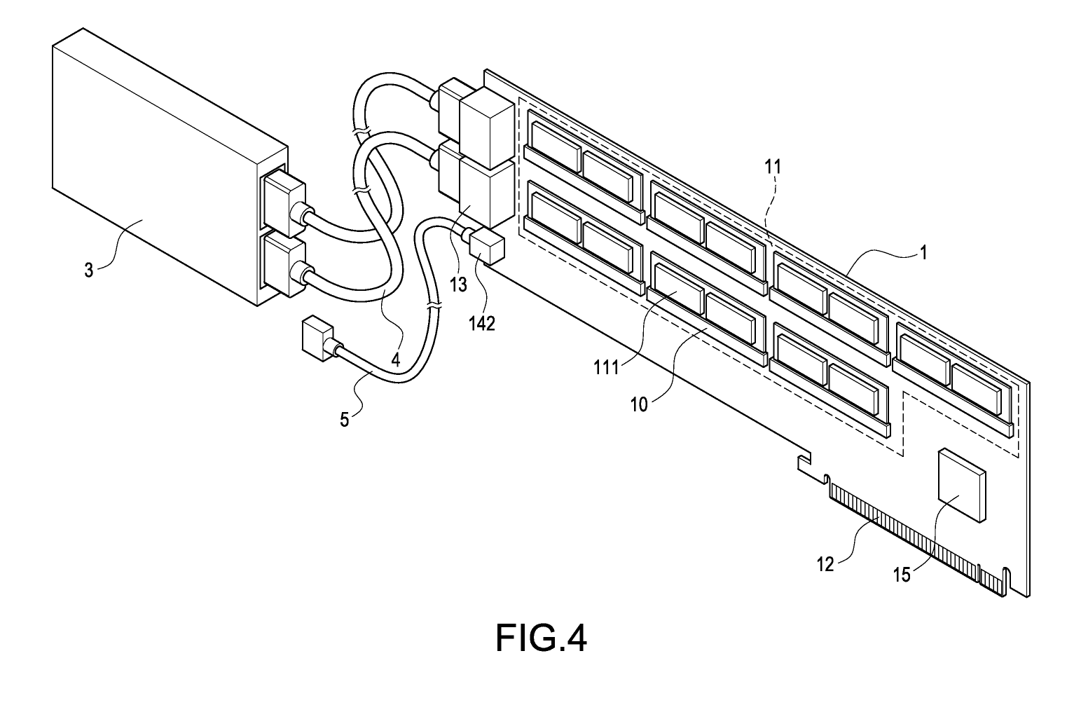

FIG. 4 is a solid diagram of the third embodiment according to the present invention. As shown in the diagram, the power supply unit 14 can also be a power cord connector 142. The solid state storage device 1 connects with an external power cord 5 via the power cord connector 142. The solid state storage device 1 connects with the computer motherboard 2 via the power cord 5 and receives power provided by the computer motherboard 2. In particular the solid state storage device 1 connects with a power supply (not shown in the diagram) of the computer motherboard 2 via the power cord 5 for receiving power provided by the power supply to assure the plurality of volatile memories 111 receiving required working power for keeping the internal data and the data is free from data lost after power failure.

FIG. 5 is a block diagram of a preferred embodiment according to the present invention. As shown in the diagram, the solid state storage device 1 of the present invention may comprise the plurality of volatile memories 111, the first transmission interface 12, at least one second transmission interface 13, the power supply unit 14, the memory controller 15, the plurality of non-volatile memories 161 and the backup storage device 3. The memory controller 15 is electrically coupled with the first transmission interface 12. The plurality of volatile memories 111 are electrically coupled with the memory controller 15 via the memory connecting socket 10 respectively. The plurality of non-volatile memories 161 are electrically coupled with the memory controller 15 via the plurality of memory connecting sockets 10 respectively. The power supply unit 14 is electrically coupled with the plurality of volatile memories 111. The at least one second transmission interface 13 is electrically coupled with the memory controller 15 and the plurality of volatile memories 111. The backup storage device 3 is electrically coupled with the memory controller 15, the plurality of volatile memories 111 and the plurality of non-volatile memories 161 by being electrically coupled with the second transmission interface 13.

The solid state storage device 1 connects with the computer motherboard 2 via the first transmission interface 12 and receives data from the computer motherboard 2. The data is saved to the plurality of volatile memories 111 via controlling the memory controller 15. It should be noted that the plurality of volatile memories 111 can be a plurality of independent storage space for saving different data. Or, the plurality of volatile memories 111 is used to generate the memory module 11 of a storage space with large capacity. In the embodiment, for example, a plurality of volatile memories 111 having thirty volatile memories, the plurality of volatile memories 111 can be used as thirty independent storage space (equals to thirty hard disks in concept) by the memory controller 15, or used as single storage space with a capacity of thirty times (equals to a hard disk of ultra data capacity), but are not limited thereto.

When data is completely saved in the plurality of volatile memories 111, the solid state storage device 1 optionally (for example before power failure) controls the plurality of volatile memories 111 to save the internal data backup to the backup memory module 16 or the backup storage device 3 via the memory controller 15. In addition, the solid state storage device 1 optionally (for example after computer re-start) controls the backup memory module 16 and the backup storage device 3 to save the internal backup data back to the plurality of volatile memories 111 via the memory controller 15. The plurality of volatile memories 111 are used as multiple solid state disks or multiple cache memories.

As mentioned above, if the memory module 11 with large capacity is generated by the plurality of volatile memories 111, the memory module 11 is electrically coupled with the second transmission interface 13, the power supply unit 14, and the memory controller 15. The backup memory module 16 communicates with the memory module 11 via the plurality of memory connecting sockets 10, and the backup storage device 3 is electrically coupled with the memory module 11 via the second transmission interface 13. The solid state storage device 1 controls the memory module 11 to save the internal data backup to the backup memory module 16 or the backup storage device 3 via the memory controller 15. In addition, the memory controller 15 controls the backup memory module 16 and the backup storage device 3 to save the internal backup data back to the memory module 11. The memory module 11 is used as a solid state disk with ultra capacity or a cache memory with ultra capacity.

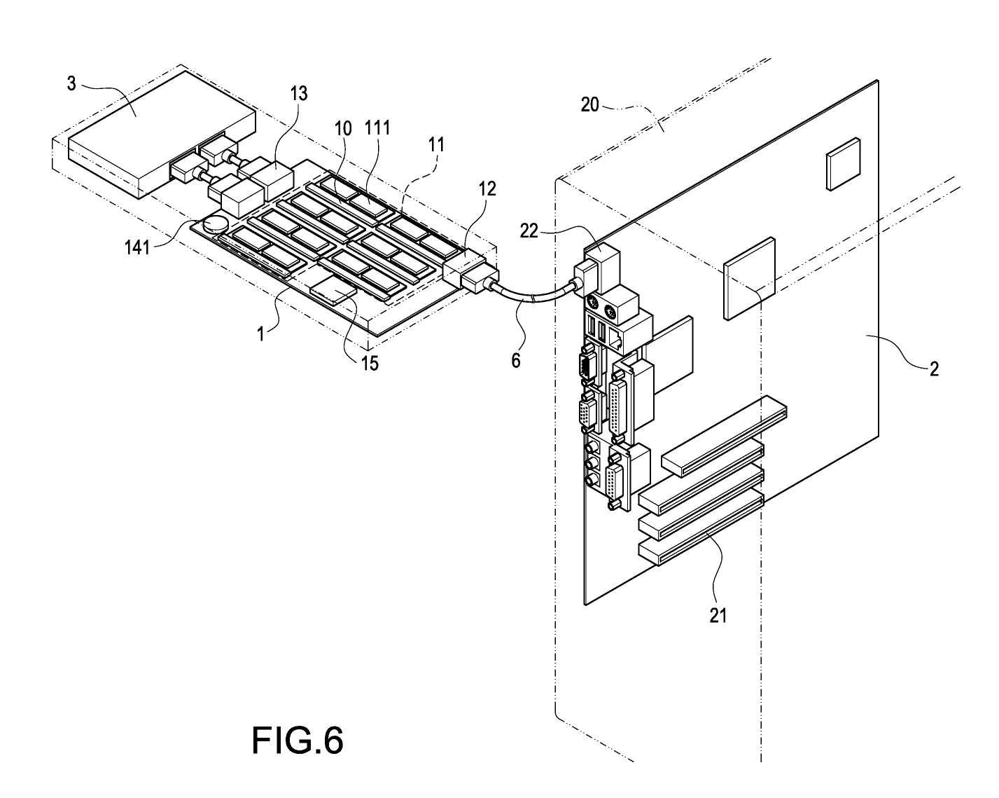

In the above embodiment, the first transmission interface 12 is a PCI-E transmission interface. The solid state storage device 1 is electrically coupled with the PCI-E slot 21 within the computer motherboard 2 via the first transmission interface 12. Accordingly, the solid state storage device 1 is installed within the computer casing 20 (the casing 20 shown in FIG. 6).

FIG. 6 is a connecting schematic diagram of a fourth embodiment according to the present invention. In the embodiment, the first transmission interface 12 can be an External Serial Advance Technology Attachment (e-SATA) transmission interface or a Universal Serial Bus 3.0 (USB3.0) transmission interface. The solid state storage device 1 connects with a connecting port 22 of the computer motherboard 2, such as an e-SATA connecting port or a USB 3.0 connecting port by connecting with a corresponding external transmission cable 6 via the first transmission interface 12, such as an e-SATA transmission cable or USB 3.0 transmission cable, but is not limited thereto. Thus, it is not required to install the solid state storage device 1 within the computer casing 20, and also it is more convenient to connect and disconnect the solid state storage device 1 from the computer.

In the embodiment shown in FIG. 6, it is difficult for the solid state storage device 1 connecting with the power supply of the computer motherboard 2 via the power cord 5. As a result, the power supply unit 14 used is the battery 141 but is not limited thereto. Thus, all forming components of the solid state storage device 1 including the backup storage device 3 can be installed in single one casing, which is more convenient for users to carry and use.

As the skilled person will appreciate, various changes and modifications can be made to the described embodiments. It is intended to include all such variations, modifications and equivalents which fall within the scope of the invention, as defined in the accompanying claims.

What is claimed is:

1. A solid state storage device using volatile memory comprising:
a first transmission interface connected with an external computer motherboard;
a memory controller electrically coupled with the first transmission interface;
a memory module comprised of a plurality of volatile memories which are electrically coupled with the memory controller via a plurality of memory connecting sockets respectively;
a power supply unit electrically coupled with the memory module providing required working power to the plurality of volatile memories; and
a backup memory module comprised of a plurality of non-volatile memories which are electrically coupled with the memory controller via a plurality of memory connecting sockets respectively;
wherein, the solid state storage device controls the memory module via the memory controller so as to save internal data backup to the backup memory module or the backup storage device, and the solid state storage device controls the backup memory module and the backup storage device so as to save the internal data backup back to the memory module.

2. The solid state storage device using volatile memory of claim 1, wherein the first transmission interface is a Peripheral Component Interconnect Express (PCI-E) transmission interface, and the solid state storage device connects with a PCI-E slot on the computer motherboard via the first transmission interface.

3. The solid state storage device using volatile memory of claim 1, wherein the first transmission interface is an external External Serial Advance Technology Attachment (e-SATA) transmission interface or an Universal Serial Bus 3.0 (USB 3.0) transmission interface, the solid state storage device connects to a connecting port on the computer motherboard by connecting with a corresponding external transmission cable via the first transmission interface.

4. The solid state storage device using volatile memory of claim 1, wherein the plurality of memory connecting sockets are Small Outline Dual In-line Memory Module (SO-DIMM) sockets.

5. The solid state storage device using volatile memory of claim 4, wherein the plurality of volatile memories is a Double Data Rate Synchronous Dynamic Random Access Memory (DDR SDRAM).

6. The solid state storage device using volatile memory of claim 5, wherein the plurality of volatile memories is a DDR3 SDRAM.

7. The solid state storage device using volatile memory of claim 4, wherein the plurality of non-volatile memories is a flash memory.

8. The solid state storage device using volatile memory of claim 7, wherein the plurality of non-volatile memories was electrically coupled with the memory controller via two or more than two memory connecting sockets, the solid state storage device the memory module internal data backup to the backup memory module with Redundant Array of Independent Disks (RAID) via the plurality of memory connecting sockets.

9. The solid state storage device using volatile memory of claim 1, wherein the power supply unit is a battery.

10. The solid state storage device using volatile memory of claim 1, wherein the power supply unit is a power cord connector, the solid state storage device connects with the external power cord via the power cord connector so as to connect with computer motherboard via external power cord.

11. The solid state storage device using volatile memory of claim 1, further comprising:
at least one second transmission interface, electrically coupled with the memory controller and the memory module; and
a backup storage device, electrically coupled with the second transmission interface, and electrically coupled with the memory controller, the memory module, and the backup memory module via the second transmission interface;
wherein, the solid state storage device controls the memory module via the memory controller so as to save internal data backup to the backup storage device, and controls the backup storage device so as to save the internal data backup back to the memory module.

12. The solid state storage device using volatile memory of claim 11, wherein the second transmission interface is a Serial Advance Technology Attachment (SATA) transmission interface.

13. The solid state storage device using volatile memory of claim 12, wherein the backup storage device is comprised of multiple hard disks, the quantity of the second transmission interfaces is two or more than two, the solid state storage device saves internal data backup of the memory module and the backup memory module to the backup storage device with RAID via the plurality of second transmission interfaces.

14. A solid state storage device using volatile memory comprising:
a first transmission interface connected with an external computer motherboard;
a memory controller electrically coupled with the first transmission interface;
a memory module having a large capacity memory space comprised of a plurality of SDRAMs which are electrically coupled with the memory controller via a plurality of SO-DIMM sockets respectively;
a backup memory module having a large capacity memory space comprised of a plurality of flash memories which are electrically coupled with the memory controller via a plurality of SO-DIMM sockets respectively;
a power supply unit electrically coupled with the memory module providing required working power to the plurality of SDRAMs;
at least one SATA transmission interface electrically coupled with the memory controller and the memory module; and
at least one backup storage device electrically coupled with the SATA transmission interface, and electrically coupled with the memory controller the memory module and the backup memory module via the SATA transmission interface;
wherein, the solid state storage device controls the memory module via the memory controller so as to save internal data backup to the backup memory module or the backup storage device, and the solid state storage device controls the backup memory module and the backup storage device so as to save the internal data backup back to the memory module.

15. The solid state storage device using volatile memory of claim 14, wherein the first transmission interface is a Peripheral Component Interconnect Express (PCI-E) transmission interface, and the solid state storage device connects with a PCI-E slot on the computer motherboard via the first transmission interface.

16. The solid state storage device using volatile memory of claim 14, wherein the first transmission interface is a e-SATA transmission interface or an USB 3.0 transmission interface, and the solid state storage device connects with a connecting port on the computer motherboard by connecting with a corresponding external transmission cable via the first transmission interface.

17. The solid state storage device using volatile memory of claim 14, wherein the plurality of flash memories are electrically coupled with the memory controller via two or more than two SO-DIMM sockets, the solid state storage device saves internal data backup of the memory module to the backup memory module with RAID via the plurality of SO-DIMM sockets.

18. The solid state storage device using volatile memory of claim 14, wherein the backup storage device is comprised of multiple hard disks, the quantity of the SATA transmission interfaces is two or more than two, the solid state storage device saves internal data backup of the memory module to the backup storage device with RAID via the plurality of SATA transmission interfaces.

19. The solid state storage device using volatile memory of claim 14, wherein the power supply unit is a battery.

20. The solid state storage device using volatile memory of claim 14, wherein the power supply unit is a power cord connector, the solid state storage device connects with the external power cord via the power cord connector so as to connect with computer motherboard via external power cord.
